(19) United States
(12) Patent Application Publication
(10) Pub. No.: US 2005/0142440 A1
(43) Pub. Date: Jun. 30, 2005

(54) Lithium ion secondary battery

(76) Inventors: Takahiro Yamaki, Hitachinaka (JP); Juichi Arai, Katsura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/017,944

(22) Filed: Dec. 22, 2004

(30) Foreign Application Priority Data
Dec. 26, 2003 (JP) 2003-435626

(51) Int. Cl. H01M 4/58; H01M 4/50; H01M 4/52

(52) U.S. Cl. 429/209; 429/231.8; 429/231.1; 429/223; 429/224; 429/231.3; 429/221; 429/220; 429/231.6

(57) ABSTRACT

A lithium ion secondary battery having high output characteristics even at an extremely low temperature, for example, −30° C. and high output power even in a low charged state. A graphite-based material having an R value (I_{RD}/I_{RG}) which is the ratio of peak intensity (I_{RD}) at 1,300 to 1,400 cm⁻¹ to peak intensity (I_{RG}) at 1,580 to 1,620 cm⁻¹ measured in its Raman spectrum of 0.3 to 0.6 and an H value (I_{H(110)}/I_{H(004)}) which is the ratio of the peak height intensity (I_{H(110)}) of the face (110) to the peak height intensity (I_{H(004)}) of the face (004) in its X-ray diffraction of 0.5 to 2.0 or a C value which is the ratio of the peak integral intensity (I_{C(110)}) of the face (110) to the peak integral intensity (I_{C(004)}) of the face (004) of 0.4 to 1.50 is used as a negative-electrode active material.

### FIELD OF THE INVENITON

The present invention relates to a lithium ion secondary battery having high output characteristics even at an extremely low temperature, for example, −30° C. and high output power even in a low charged state.

### BACKGROUND OF THE INVENTION

Since a lithium ion secondary battery is lighter and has higher output characteristics than other batteries such as a nickel hydrogen secondary battery and a lead storage battery, it is attracting much attention as a high-output power source for electric cars and hybrid electric cars.

In a hybrid electric car, the state of charge (SOC) of the battery changes during its use. Therefore, it is desired that the used lithium ion secondary battery should have high output power stably in a wide range of SOC. In recent years, in consideration of its outdoor use in a very cold district, high output power at an extremely low temperature, for example, −30° C. has been desired.

In general, as SOC becomes lower, the output of the lithium ion secondary battery drops. This is because the voltage of the battery as SOC becomes lower and when a large current is discharged to obtain high output, a voltage drop becomes significantly large due to a small amount of the remaining electricity. Therefore, the development of a lithium ion secondary battery having high output characteristics even at an extremely low temperature, for example, −30° C. and high output power even in a low SOC has been desired.

In general, negative-electrode active substances for use in the lithium ion secondary battery are roughly divided into graphite-based and amorphous carbon-based active substances. Graphite has a structure that the hexagonal planes of carbon atoms are layered regularly and the insertion and elimination reactions of a lithium ion proceed from the edges of the layered hexagonal planes as the negative-electrode active substance of the lithium ion secondary battery. At the same time, a lithium ion is inserted between the layers of the hexagonal net faces. Due to the insertion of a lithium ion between the layers of the hexagonal planes, the potential of graphite is stable in a low SOC. Therefore, a lithium ion secondary battery comprising a graphite-based active substance has stable output in a low SOC but its output value tends to drop especially at a low temperature.

Meanwhile, amorphous carbon has hexagonal planes which are irregularly layered or does not have a hexagonal structure. The insertion and elimination reactions of a lithium ion proceed on the entire surface of a particle and at the same time, the potential of the amorphous carbon rises when SOC becomes low because it has many sites for inserting a lithium ion. Therefore, a lithium ion secondary battery comprising an amorphous carbon active substance can generally obtain high output even at a low temperature but its output tends to greatly drop in a low SOC. Consequently, it is technically extremely difficult to realize a lithium ion secondary battery having high output characteristics in a wide range of SOC at an extremely low temperature, for example, −30° C.

As an example in which output characteristics at an extremely low temperature are improved, Japanese Laid-open Patent Application No. 2002-117846 discloses a lithium ion secondary battery which comprises a carbon fiber having a specific surface area as a negative-electrode active substance.

However, the above lithium ion secondary battery of the prior art was not designed to achieve high output characteristics in a wide range of SOC at an extremely low temperature, for example, −30° C. and unsatisfactory in terms of output characteristics.

### SUMMARY OF THE INVENTION

It is an object of the present invention to provide a lithium ion secondary battery which has high output characteristics even at an extremely low temperature, for example, −30° C., and high output power even in a low charged state (SOC).

The inventors of the present invention have found that a lithium ion secondary battery having high output even at an extremely low temperature can be obtained by controlling the non-crystallinity of a negative-electrode graphite surface layer and the crystal orientation of graphite. The present invention has been accomplished based on this finding.

According to a first aspect of the present invention, there is provided a lithium ion secondary battery which comprises electrodes consisting of a positive electrode coated with a positive-electrode mix containing a positive-electrode active substance, a negative electrode coated with a negative-electrode mix containing a negative-electrode active substance and a separator and which contains an electrolyte, wherein the output density at −30° C. based on the total weight of the electrodes is 230 W/kg or more at a SOC (charge depth) of 50% and 150 W/kg or more at a SOC of 30%.

According to a second aspect of the present invention, there is provided a lithium ion secondary battery, wherein the negative-electrode active substance is a graphite-based material having an R value (I_{RD}/I_{RG}) which is the ratio of peak intensity (I_{RD}) at 1,300 to 1,400 cm⁻¹ to peak intensity (I_{RG}) at 1,580 to 1,620 cm⁻¹ measured from its Raman spectrum of 0.3 to 0.6 and an H value (I_{H(110)}/I_{H(004)}) which is the ratio of the peak height intensity (I_{H(110)}) of the face (110) to the peak height intensity (I_{H(004)}) of the face (004) in its X-ray diffraction of 0.5 to 2.0 or a C value (I_{C(110)}/I_{C(004)}) which is the ratio of the peak integral intensity (I_{C(110)}) of the face (110) to the peak integral intensity (I_{C(004)}) of the face (004) of 0.4 to 1.50. These measurement values are obtained by measuring the above graphite in a powder state and not a negative electrode board.

The lithium ion secondary battery of the present invention has high-output characteristics even at an extremely low temperature, for example, −30° C. and high output power even in a low charged state. That is, a lithium ion secondary battery having high output characteristics in a wide range of SOC can be provided. Particularly, when the lithium ion secondary battery of the present invention is used in an electric car, its output characteristics at the time of start are excellent.

### BRIEF DESCRIPTION OF THE DRAWINGS

FIG. 1 is a diagram of an example of the cylindrical lithium ion secondary battery of the present invention; and

FIG. 2 shows the constitution of the electric car of the present invention.

### DETAILED DESCRIPTION OF THE PREFERRED EMBODIMENTS

In the lithium ion secondary battery of the present invention, a graphite-based material having an R value (I_{RD}/I_{RG}) in its Raman spectrum of 0.3 to 0.6 is used as a negative-electrode active substance. The peak at 1,580 to 1,620 cm⁻¹ measured from the Raman spectrum is considered to signify the regular, layer lamination of graphite hexagonal plane and the peak at 1,300 to 1,400 cm⁻¹ is considered to signify the lamination disorder of the hexagonal layer and amorphous bond having no π electron. Therefore, it can be said that the R value (I_{RD}/I_{RG}) which is the ratio of peak intensity (I_{RD}) at 1,300 to 1,400 cm⁻¹ to peak intensity (I_{RG}) at 1,580 to 1,620 cm⁻¹ is an index of the crystallinity of a graphite-based material. When the R value is smaller than 0.3, the crystallinity of graphite becomes high with the result of reduced output characteristics at −30° C. and when the R value is larger than 0.6, the crystallinity becomes low with the result of reduced output characteristics in a low SOC.

In the lithium ion secondary battery of the present invention, a graphite-based material having an H value (I_{H(110)}/I_{H(004)}) which is the ratio of peak height intensity between the face (110) and the face (004) in its X-ray diffraction of 0.5 to 2.0 or a C value (I_{C(110)}/I_{C(004)}) which is the ratio of peak integral intensity between the face (110) and the face (004) of 0.4 to 1.50 is used as a negative-electrode active material. The ratio of peak intensity between the faces (110) and (004) in the X-ray diffraction signifies the crystal orientation of the graphite-based material. When the H value or C value is small, the expanses of the hexagonal planes become large in the direction of the plane and when the H value or C value is large, the proportion of the edges of the layered hexagonal plane becomes large. When the H value (I_{H(110)}/I_{H(004)}) which is the ratio of peak height intensity is smaller than 0.5 or when the C value (I_{C(110)}/I_{C(004)}) which is the ratio of peak integral intensity is smaller than 0.4, the proportion of the edges of the hexagonal plane faces from which the insertion and elimination reactions of a lithium ion proceed decreases with the result of reduced output characteristic at −30° C. and when the H value is larger than 2.0 or the C value is larger than 1.50, the battery voltage drops with the result of reduced output characteristics in a low SOC.

To obtain the R value of the graphite-based material in the present invention, the Raman spectrum of the material is obtained by illuminating a graphite-based material powder with argon laser light having a wavelength of 514.5 nm and an output of 50 W and measuring its Raman scattered light with a spectrometer. The R value is obtained by measuring the peak intensity heights of a peak at 1,580 to 1,620 cm⁻¹ and a peak at 1,300 to 1,400 cm⁻¹ from the base-line of the obtained spectrum.

To obtain the H value and C value of the graphite-based material in the present invention, a reflection diffraction type powder X-ray diffraction method is used. The graphite-based material powder is exposed to CuKα rays at a tube voltage of 50 kV and a tube current of 150 mA, using Cu as a target, and diffracted rays are measured with a goniometer. Thereafter, the peaks are separated to obtain the powder X-ray diffraction spectrum of the material with CuKα1 rays. The H value is calculated by obtaining the height of the diffraction peak of the face (004) at a 2θ of 52 to 57° and the height of the diffraction peak of the face (110) at a 2θ of 75 to 80°. The C value is calculated by obtaining the integral intensity of the diffraction peak of the face (004) and the integral intensity of the diffraction peak of the face (110).

As a preferred example of the lithium ion secondary battery of the present invention, a graphite-based material which has a half-value width A of a peak at 1,300 to 1,400 cm⁻¹ measured from its Raman spectrum of 40 to 100 cm⁻¹ is used as the negative-electrode active material.

The peak at 1,300 to 1,400 cm⁻¹ is considered to signify the disorder of the hexagonal planes or the amorphous bond. As the degree of the disorder increases, the above Δ value becomes larger. When the Δ value is smaller than 40 cm⁻¹, the disorder required to promote the insertion and elimination reactions of a lithium ion with low resistance becomes small, whereby output characteristics at −30° C. may deteriorate. When the Δ value is larger than 100 cm⁻¹, the lamination of the hexagonal planes required to achieve a stable potential is disordered with the result of reduced output characteristics in a low SOC.

In order to obtain the Δ value of the graphite-based material in the present invention, the Raman spectrum of the material is obtained in the same manner as the above R value to acquire the height of a peak at 1,300 to 1,400 cm⁻¹ from the base line from which the width of the peak at a height which is ½ of the above height is then known.

As a more preferred example of the lithium ion secondary battery of the present invention, a graphite-based material having an average particle diameter of 2 to 20 μm is used as the negative-electrode active material. When the average particle diameter is larger than 20 μm, the diffusion distance of Li from the surface to the interior of the negative-electrode active material becomes long with the result of reduced output characteristics. When the average particle diameter is smaller than 2 μm, the proportion of fine particles in sub-micron order inevitably increases, whereby particles which are not electronically contacted to one another, that is, do not function as an active substance grow in quantity, thereby reducing output characteristics.

To obtain the average particle diameter in the present invention, a light diffraction method is used. The graphite-based material is dispersed in distilled water containing a small amount of a surfactant and exposed to a laser beam having a wavelength of 633 nm, and the diffracted light of the particles is analyzed to obtain a particle size distribution. The average particle diameter (D50) at a volume of 50% is then obtained from this particle size distribution.

As a still preferred example of the lithium ion secondary battery of the present invention, the coating weight of a negative-electrode mix is 1.5 to 6.0 mg/cm² and the above negative-electrode mix contains 1 to 10 wt % of a conducting agent.

When the coating weight of the negative-electrode mix is lower than 1.5 mg/cm², a large amount of lithium is discharged from a small amount of the active substance at the time of output at −30° C., thereby reducing the output power of the active material. When the coating weight of the negative-electrode depolarizing mix is higher than 6.0 mg/cm², the diffusion distance in the electrode of a lithium ion discharged into the electrolyte from the active material in the electrode becomes long, thereby reducing the output at −30° C.

The conducting agent has the function of securing electron conductivity between graphite-based materials which are negative-electrode active materials contained in the negative-electrode mix to improve the output characteristics at −30° C. Examples of the conducting agent include carbon black, acetylene black and carbon fiber. When the amount of the conducting material is smaller than 1 wt %, electron conductivity between negative-electrode active materials becomes unsatisfactory, thereby reducing the output power. Even when the conducting material is added in an amount of more than 10 wt %, significant improvement in output power cannot be expected and, as the amount of the active material decreases, the output power may drop.

As a further preferred example of the lithium ion secondary battery of the present invention, the solvent for the electrolyte contains a nitrate and/or the above electrolyte contains a salt of lithium and organic boric acid (the boric acid contains a carboxyl-derived group having a halogen-substituted alkyl group).

The above nitrite-based solvent has low viscosity at a low temperature. When the electrolyte contains this nitrate-based solvent, the diffusion speed of lithium in the electrolyte at −30° C. increases and the output power improves. The salt of lithium and organic boric acid has the effect of increasing the dissociation degree of lithium particularly at a low temperature. When this salt is contained in the electrolyte, the concentration of a lithium ion in the electrolyte at −30° C. rises and the output power improves.

As a still further preferred example of the lithium ion secondary battery of the present invention, the positive-electrode active material contains a layered composite oxide represented by the formula LiNiₓMn_{y}Co_{z}M_{α}O₂ (M: Fe, Cr, Cu, Al, Mg or Si, x+y+z+α=1, 0.2≦x≦0.5, 0.25≦y≦0.7, 0.1≦z≦0.5, 0≦α≦0.1).

The above composite oxide has a layered crystal structure that a lithium ion layer, an oxygen ion layer and a layer comprising elemental Ni, Mn, Co and elemental M are placed one upon another. The above composite oxide comprises Ni, Mn and Co in a well balanced manner. The above Ni, Mn and Co are elements required for obtaining the necessary capacity of the positive-electrode active material and their ion radiuses differ slightly from one to another. By well balancing Ni, Mn and Co with different ion radiuses to suitably control the distance between lithium ion layers, lithium ions can diffuse quickly at an extremely low temperature of −30° C., thereby obtaining a high-output lithium ion secondary battery.

α in the above formula signifies the content of elemental M constituting the above active material. Although the type of elemental M is not particularly limited, it is at least one selected from Fe, Cr, Cu, Al, Mg and Si and may not be contained as understood from the range of α, that is, 0≦α≦0.1. When α>0.1, the contents of Ni, Mn and Co become low and the capacity of the positive-electrode active material decreases. As a result, stable output characteristics are not obtained. Therefore, the preferred range of α is 0≦α≦0.1.

Further, as still another preferred example of the lithium ion secondary battery of the present invention, the positive-electrode active material contains an Ni-based layered composite oxide represented by LiNiₓM₁₋ₓO₂ (M: Mn, Co, Fe, Cr, Cr, Cu, Al or Mg, 0.7≦x≦0.95).

The above Ni-based composite oxide has a layered crystal structure that a lithium ion layer, an oxygen ion layer and a layer essentially composed of elemental Ni are placed one upon another. When the above composite oxide comprises Ni and substituent M (M: Mn, Co, Fe, Cr, Cu, Al or Mg) and the composition of the above composite oxide is controlled to suitably adjust the distance between lithium ion layers, a lithium ion can diffuse swiftly at an extremely low temperature of −30° C., thereby obtaining a high-output lithium ion secondary battery.

X in the above formula shows the content of elemental M constituting the above active material and is desirably at least one selected from Mn, Co, Fe, Cr, Cu, Al and Mg, and the range of X is 0.7≦x≦0.95. When x is larger than 0.95 or smaller than 0.7, the diffusion of a lithium ion between the layers of the composite oxide is hindered and the output characteristics of the composite oxide deteriorate. Therefore, the preferred range of X is 0.7≦x≦0.95.

The lithium ion secondary battery of the present invention comprises electrodes consisting of (1) a positive electrode formed by applying a positive-electrode mix containing a positive-electrode active material which contains the above composite oxide or Ni-based composite oxide, (2) a negative electrode formed by applying a negative-electrode mix containing a negative-electrode active material which is a graphite-based material having the above R value, C value or H value, desirably the above Δ value and the above average particle diameter and preferably the above amount of the conducting agent to the above preferred coating weight and (3) a separator and an electrolyte, all of which are housed in a battery case.

To manufacture the positive-electrode, the above composite oxide is desirably selected as the positive-electrode active material. It is also possible to use lithium-cobalt-oxide, what is obtained by substituting a small amount of cobalt thereof with another element, and a spinel-based composite oxide typified by lithium manganese oxide. A positive-electrode depolarizing mix slurry is prepared by adding a suitable amount of a conducting agent such as graphite, carbon, carbon black or carbon fiber to a positive-electrode active material, further adding a binder dissolved or dispersed in an appropriate solvent to the obtained mixture and mixing them well. A fluorine-based resin such as polyvinylidene fluoride (PVDF) may be used as the binder and N-methyl-pyrrolidone (NMP), for example, may be used as the solvent for dissolving the resin. This positive-electrode mix slurry is applied to aluminum metal foil or the like and dried and to both sides of the metal foil and dried in the same manner as above, and the resulting laminate is then compression molded as required and cut to a desired size to produce a positive electrode.

To manufacture a negative electrode, a graphite-based material having the above R value, C value or H value and desirably the above Δ value and average particle diameter is selected as the negative-electrode active material. A negative-electrode mix slurry is prepared by preferably adding a conducting agent such as carbon black, acetylene black or carbon fiber to the negative-electrode active material in an amount of 1 to 10 wt % based on the weight of the dried negative-electrode mix, adding PVDF dissolved in NMP as a binder and mixing them well. This negative-electrode depolarizing mix slurry is applied to metal foil such as Cu metal foil to ensure that the coating weight of the mix after drying preferably becomes 1.5 to 6.0 g/cm² and dried and further to both sides of the metal foil and dried in the same manner as above, and the resulting laminate is then compression molded as required and cut to a desired size.

To manufacture a cylindrical battery, the following process is employed. A separator composed of a porous insulating film having a thickness of 15 to 50 μm is sandwiched between the positive electrode and the negative electrode as means of electrically insulating them from each other and wound cylindrically to manufacture electrodes and inserted into a battery vessel made of SUS or aluminum. Resin porous insulating films such as polyethylene (PE) and polypropylene (PP) insulating films, laminates thereof and what contain an inorganic compound such as alumina dispersed therein may be used as the separator.

A non-aqueous electrolyte prepared by dissolving a lithium salt in a non-aqueous solvent for electrochemically bonding a positive electrode to a negative electrode is injected into this battery vessel in a working container in dry air or inert gas atmosphere and the vessel is sealed to prepare a battery.

The lithium salt is the source of a lithium ion that difuses in the electrolyte by the charge and discharge of the battery, and LiClO₄, LiCF₃SO₃, LiPF₆, LiBF₄ and LiAsF₆ may be used alone or in combination as the lithium salt. Desirably, it is a salt of lithium and organic boric acid such as lithium tetrakis(trifluoroacetate) borate (LB). The organic solvent may comprise a linear or cyclic carbonate as the essential ingredient. It may be mixed with an ester or ether. A nitrate-based solvent such as methyl acetate (MA) is preferably used as the solvent. Examples of the carbonate include ethylene carbonate (EC), propylene carbonate, butylenes carbonate, dimethyl carbonate (DMC), diethyl carbonate (DEC), methylethyl carbonate and diethyl carbonate. They may be used alone or in combination as the non-aqueous solvent.

To manufacture a square battery, the following process is used. The application of the positive electrode and the negative electrode is carried out in the same manner as the manufacture of the above cylindrical battery. To manufacture a square battery, electrodes are manufactured with a square center pin as the center. As in the case of the cylindrical battery, the electrodes are put into the battery vessel which is sealed after the injection of the electrolyte. A laminate consisting of a separator, positive electrode, separator, negative electrode and separator in the mentioned order may be used in place of the electrodes.

Another embodiment of the present invention is an apparatus comprising the above-mentioned lithium ion secondary battery of the present invention, a power unit such as a motor which uses the above lithium ion secondary battery as at least part of its power source and a drive unit which is driven by the power unit.

Examples of the above apparatus include electric cars and light vehicles which have a motor as a power unit and wheels as drive units, hybrid electric cars having an internal combustion engine and a fuel cell as power units, and power tools having a drill as a drive unit.

### EXAMPLE 1

18650 cylindrical lithium ion secondary batteries (Battery 1), (Battery 2) and (Battery 3) were manufactured as Example 1 of the present invention as follows.

A positive electrode was first manufactured. A composite oxide powder represented by LiNi_{0.34}Mn_{0.33}Co_{0.33}O₂ was used as the positive-electrode active material. 9 wt % of flaky graphite as a conducting agent, 1.7 wt % of acetylene black and a solution containing 4.3 wt % of PVDF dissolved in NMP as a binder were added to 85 wt % of this positive-electrode active material and mixed together to prepare a positive-electrode mix slurry. This slurry was substantially uniformly and equally applied to 20 μm-thick aluminum foil (positive-electrode current collector) and dried at 80° C. and further to both sides of the aluminum foil and dried likewise. The coating weight on the positive electrode was adjusted to ensure that the weight of the dried mix became 8.0 mg/cm². Thereafter, the obtained laminate was compression molded with a roll press, cut to a desired size and welded to an aluminum foil tab for taking out a current to manufacture a positive electrode.

A negative electrode was then manufactured. As the negative-electrode active material, a graphite-based material A having an average particle diameter of 5.7 μm, graphite-based material B having an average particle diameter of 19 μm and graphite-based material C having an average particle diameter of 10.3 μm were used for (Battery 1), (Battery 2) and (Battery 3), respectively. As for the H value which is the height intensity ratio of the peak of the face (110) to the peak of the face (004) and the C value which is the integral intensity ratio of the peak of the face (110) to the peak of the face (004) in the X-ray diffraction, the graphite-based material A had an H value of 1.03 and a C value of 0.41, the graphite-based material B had an H value of 1.98 and a C value of 1.49, and the graphite-based material C had an H value of 0.53 and a C value of 0.41. As for the R value which is the intensity ratio of peak intensity at 1,300 to 1,400 cm⁻¹ to peak intensity at 1,580 to 1,620 cm⁻¹ and the Δ value which is the half-value width of a peak at 1,300 to 1,400 cm⁻¹ in the Raman spectrum, the graphite-based material A had an R value of 0.47 and a Δ value of 52 cm⁻¹, the graphite-based material B had an R value of 0.57 and a Δ value of 78 cm⁻¹, and the graphite-based material had an R value of 0.31 and a Δ value of 43 cm⁻¹. A negative-electrode mix slurry was prepared by adding 5 wt % of acetylene black as a conducting agent and a solution containing 4 wt % of PVDF dissolved in NMP to 91 wt % of an active material and mixing them together. This slurry was applied to both sides of a 15 μm-thick rolled copper foil (negative-electrode current collector) substantially uniformly and equally in the same way as for the positive electrode. The coating weight of the negative electrode was controlled to ensure that the weight of the dried mix became 3.0 mg/cm². After application, the obtained laminate was compression molded with a roll press, cut to a desired size and welded to a nickel foil lead tab to obtain a negative electrode.

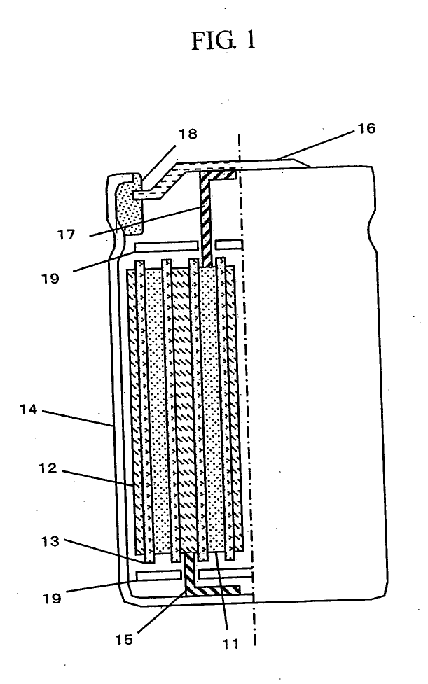

As shown in FIG. 1, a cylindrical battery having a length of 65 mm and a diameter of 18 mm was manufactured by using the above obtained positive electrode and negative electrode. The positive electrode 11 and the negative electrode 12 were wound round with a 25 μm-thick separator 13 made of finely porous polypropylene interposed therebetween to prepare electrodes and measure the total weight of the electrodes. The electrodes were put into a battery vessel 14 made of SUS, a negative-electrode lead tab 15 was welded to the bottom of the vessel, and a positive-electrode lead tab 17 was welded to a sealing lid 16 which serves as a positive-electrode current terminal. After the electrolyte was injected into the battery vessel, the sealing lid 16 having the positive-electrode terminal was calked into the battery vessel 14 via a packing 18 to seal up the battery vessel 14, thereby producing a cylindrical battery. A solution prepared by dissolving 1 mol/l of LiPF₆ in a mixed solvent of EC, DMC and DEC in a volume ratio of 1:1:1 was used as the electrolyte.

(Measurement of Output Density at −30° C.)

The output density at −30° C. of Example 1 was measured in a thermostatic chamber into which a current line and a voltage line were inserted was measured as follows.

The rated capacity of the battery was first measured. The charging and discharging of the manufactured lithium ion secondary battery were repeated 3 times at 20° C. and the 3^{rd} discharge capacity was taken as the rated capacity of the battery. As for charging conditions, constant-current constant-voltage charging was carried out at a charge current equivalent to 0.33 C and an upper limit voltage of 4.2 V for 4 hours. As for discharging conditions, constant-current discharging was carried out at a discharge current equivalent to 0.33 C and a lower limit voltage of 3.0 V.

The output density at an SOC of 50% and an SOC of 30% and at −30° C. was measured. After 4 hours of constant-current constant-voltage charging at a current equivalent to 0.33 C and an upper limit voltage of 4.2 V at 20° C., electricity equal to 50% of the rated capacity was discharged to achieve an SOC of 50%. Then, the inside temperature of the thermostatic chamber was set to −30° C. and the measurement of the output density was started after 4 hours. When the rated capacity was 1 C, a discharge current was discharged at 1 C for 10 seconds, and open circuit voltage before discharge (V₀) and voltage after 10 seconds of discharge (V₁₀) were measured to obtain a voltage drop (ΔV) which is the difference between them (V₀−V₁₀). Subsequently, the same amount of electricity as the amount of discharged electricity was charged and discharge current was changed to 5 C and 10 C to obtain voltage drops (ΔV) similarly. After discharge was carried out to achieve an SOC of 30%, ΔV at a discharge current of 1 C, 5 C and 10 C was obtained in the same manner as above. The maximum current values (I_{MAX}) at an SOC of 50% and an SOC of 30% were calculated by obtaining a voltage drop (ΔV) for a discharge current value by extrapolation and assuming that a discharge terminal voltage of 3.0 V was reached in 10 seconds and multiplied by 3.0 V to obtain the output of the lithium ion secondary battery. The product of the above output value and the total weight of the electrodes was taken as output density.

Table 1 shows the used graphite-based materials, the H values, C values, R value, Δ value and average particle diameter of the materials and the measured results of output densities at −30° C. at an SOC of 50% and an SOC of 30% for each battery of Example 1. As shown in Table 1, the output density of (Battery 1) was 251 W/kg at an SOC of 50% and 161 W/kg at an SOC of 30%, the output density of (Battery 2) was 258 W/kg at an SOC of 50% and 155 W/kg at an SOC of 30%, and the output density of (Battery 3) was 245 W/kg at an SOC of 50% and 160 W/kg at an SOC of 30%. All of the batteries in Example 1 had an output density of 230 W/kg or more at an SOC of 50% and 150 W/kg or more at an SOC of 30%, which means that they were superior in output density to the batteries of Comparative Examples to be mentioned hereinafter.

TABLE 1

| | | | | | Raman | | | | |
|---|---|---|---|---|---|---|---|---|---|
| | | | X-ray | | spectrum | | Average | | |
| | | Negative-electrode | diffraction | | | Δ | particle | Output at −30° C. | |
| | | active | H | C | R | value | diameter | SOC of | SOC of |
| | Battery | material | value | value | value | (cm)⁻¹ | (μm) | 50% | 30% |
| Example 1 | Battery 1 | Graphite-based | 1.03 | 0.41 | 0.47 | 52 | 5.7 | 251 | 161 |
| | | material A | | | | | | | |
| | Battery 2 | Graphite-based | 1.98 | 1.49 | 0.57 | 78 | 19.8 | 258 | 155 |
| | | material B | | | | | | | |
| | Battery 3 | Graphite-based | 0.53 | 0.41 | 0.31 | 43 | 10.3 | 245 | 160 |
| | | material C | | | | | | | |
| Comparative | Comparative | Graphite-based | 0.41 | 0.26 | 0.24 | 41 | 9.8 | 210 | 145 |
| example 1 | battery 1 | material Z | | | | | | | |
| | Comparative | Graphite-based | 3.55 | 2.08 | 0.71 | 89 | 13.6 | 263 | 138 |
| | battery 2 | material X | | | | | | | |
| Example 2 | Battery 4 | Graphite-based | 1.63 | 1.2 | 0.54 | 105 | 22 | 252 | 150 |
| | | material D | | | | | | | |
| | Battery 5 | Graphite-based | 1.23 | 1.11 | 0.45 | 70 | 1.9 | 241 | 152 |
| | | material E | | | | | | | |
| | Battery 6 | Graphite-based | 1.22 | 0.82 | 0.37 | 36 | 9 | 235 | 151 |
| | | material F | | | | | | | |

### COMPARATIVE EXAMPLES

18650 cylindrical lithium ion secondary batteries (Comparative Battery 1) and (Comparative Battery 2) were manufactured as Comparative Example 1 as follows.

As the negative-electrode active materials, a graphite-based material Z having an average particle diameter of 9.8 μm and a graphite-based material X having an average particle diameter of 13.6 μm were used in (Comparative Battery 1) and (Comparative Battery 2), respectively. The graphite-based material Z had an H value of 0.41, a C value of 0.26, an R value of 0.24 and a Δ value of 41 cm⁻¹. The graphite-based material X had an H value of 3.55, a C value of 2.08, an R value of 0.71 and a Δ value of 89 cm⁻¹. Lithium ion secondary batteries were manufactured in the same manner as in Example 1 except for the above.

The output densities of the obtained (Comparative Battery 1) and (Comparative Battery 2) were measured in the same manner as in Example 1. As shown in Table 1, the output density of (Comparative Battery 1) was 210 W/kg at an SOC of 50% and 145 W/kg at an SOC of 30% and the output density of (Comparative Battery 2) was 263 W/kg at an SOC of 50% and 138 W/kg at an SOC of 30%. All the batteries of Comparative Examples had an output density lower than 230 W/kg at an SOC of 50% and lower than 150 W/kg at an SOC of 30%, which means that they were inferior to those of Example 1, Example 2 and Example 4 in output density.

### EXAMPLE 2

18650 cylindrical lithium ion secondary batteries (Battery 4), (Battery 5) and (Battery 6) were manufactured as Example 2 of the present invention as follow.

As the negative-electrode active materials, a graphite-based material D having an average particle diameter of 22 μm, a graphite-based material E having an average particle diameter of 1.9 μm and a graphite-based material F having an average particle diameter of 9.0 μm were used in (Battery 4), (Battery 5) and (Battery 6), respectively. The graphite-based material D had an H value of 1.63, a C value of 1.20, an R value of 0.54 and a Δ value of 105 cm⁻¹ The graphite-based material E had an H value of 1.23, a C value of 1.11, an R value of 0.45 and a Δ value of 70 cm⁻¹. The graphite-based material F had an H value of 1.22, a C value of 0.82, an R value of 0.37 and a Δ value of 36 cm⁻¹. Lithium ion secondary batteries were manufactured in the same manner as in Example 1 except for the above.

Table 1 shows the used graphite-based materials, the H values, C values, R values, Δ values and average particle diameters of the materials and the measurement results of output densities at −30° C. at an SOC of 50% and an SOC of 30% for each battery of Example 2. As shown in Table 1, the output density of (Battery 4) was 252 W/kg at an SOC of 50% and 150 W/kg at an SOC of 30%, the output density of (Battery 5) was 241 W/kg at an SOC of 50% and 152 W/kg at an SOC of 30%, and the output density of (Battery 6) was 235 W/kg at an SOC of 50% and 151 W/kg at an SOC of 30%. All of the batteries in Example 2 had an output density of 230 W/kg or more at an SOC of 50% and 150 W/kg or more at an SOC of 30%, which means that all of the batteries were superior to the batteries of Comparative Examples in output density. However, they were inferior to the batteries of Example 1 in output density at an SOC of 30%.

### EXAMPLE 3

18650 cylindrical lithium ion secondary batteries (Battery 7), (Battery 8), (Battery 9) and (Battery 10) were manufactured as Example 3 of the present invention as follows.

The graphite-based material A was used as the negative-electrode active material, the amount of the conducting agent contained in the negative-electrode depolarizing mix and the coating weight of the depolarizing mix were changed and thereby, the coating weight of the positive electrode was changed. In (Battery 7), the amount of the conducting agent was 0.6 wt %, the coating weight of the negative electrode was 1.4 mg/cm², and the coating weight of the positive electrode was 5 mg/cm². In (Battery 8), the amount of the conducting agent was 1.2 wt %, the coating weight of the negative electrode was 2.0 mg/cm², and the coating weight of the positive electrode was 6 mg/cm². In (Battery 9), the amount of the conducting agent was 9.5 wt %, the coating weight of the negative electrode coating was 5.0 mg/cm² and the coating weight of the positive electrode was 8 mg/cm². In (Battery 10), the amount of the conducting agent was 12 wt %, the coating weight of the negative electrode was 6.2 mg/cm², and the coating weight of the positive electrode was 10 mg/cm². Lithium ion secondary batteries were manufactured in the same manner as in Example 1 except for the above.

Table 2 shows the amount of the conducting agent contained in the negative-electrode depolarizing mix, the coating weight of the depolarizing mix and the measurement results of output densities at −30° C. at an SOC of 50% and an SOC of 30% for (Battery 1) of Example 1 and the batteries of Example 3. As shown in Table 2, the output density of (Battery 7) was 234 W/kg at an SOC of 50% and 153 W/kg at an SOC of 30%, the output density of (Battery 8) was 240 W/kg at an SOC of 50% and 156 W/kg at an SOC of 30%, the output density of (Battery 1) was 251 W/kg at an SOC of 50% and 161 W/kg at an SOC of 30%, the output density of (Battery 9) was 246 W/kg at an SOC of 50% and 154 W/kg at an SOC of 30% and the output density of (Battery 10) was 231 W/kg at an SOC of 50% and 150 W/kg at an SOC of 30%. All of the batteries of Example 3 had an output density of 230 W/kg or more at an SOC of 50% and 150 W/kg or ore at an SOC of 30%, which means that they were superior to the batteries of Comparative Examples in output density. (Battery 8), (Battery 1) and (Battery 9) had an output density of 240 W/kg or more at an SOC of 50% which were higher than those of (Battery 7) and (Battery 10).

TABLE 2

| | | | Coating | | | |
|---|---|---|---|---|---|---|
| | | | weight of | Amount of | | |
| | | | negative- | negative- | | |
| | | | electrode | electrode | | |
| | | Negative-electrode | depolarizing | conducting | output at −30° C. (W/kg) | |
| | | active | mix | agent | SOC of | SOC of |
| | Battery | material | (mg/cm²) | (Wt %) | 50% | 30% |
| Example 3 | Battery 7 | Graphite-based | 1.4 | 0.6 | 234 | 153 |
| | | material A | | | | |
| | Battery 8 | Graphite-based | 2 | 1.2 | 240 | 156 |
| | | material A | | | | |
| Example 1 | Battery 1 | Graphite-based | 3 | 5 | 251 | 161 |
| | | material A | | | | |
| Example 3 | Battery 9 | Graphite-based | 5 | 9.5 | 246 | 154 |
| | | material A | | | | |
| | Battery 10 | Graphite-based | 6.2 | 12 | 231 | 150 |
| | | material A | | | | |

### EXAMPLE 4

A 18650 lithium ion secondary battery (Battery 11) was manufactured as Example 4 of the present invention as follows.

An electrolyte prepared by dissolving 1 mol/l of LiPF₆ and 0.01 mol/l of lithium tetrakis(trifluoroacetate)borate(LB) in a mixed solvent of EC, DMC, DEC and methylacetate(MA) in a volume ratio of 3:3:3:1 was used. The lithium ion secondary battery was manufactured in the same manner as (Battery 1) of Example 1 except for the above.

Table 3 shows the electrolytes and the measurement results of output densities at −30° C. at an SOC of 50% and an SOC of 30% for (Battery 1) of Example 1 and (Battery 11) of Example 4. As shown in Table 3, the output density of (Battery 1) was 251 W/kg at an SOC of 50% and 161 W/kg at an SOC of 30%. The output density of (Battery 11) of Example 4 was 230 W/kg or more at an SOC of 50% and 150 W/kg or more at an SOC of 30%, which means that (Battery 11) was superior to those of Comparative Examples and (Battery 1) of Example 1 in output density.

TABLE 3

| | | | | Output at −30° C. | |
|---|---|---|---|---|---|
| | | Negative- | | (W/kg) | |
| | | electrode active | | SOC of | SOC of |
| | Battery | material | Electrolyte | 50% | 30% |
| Example 1 | Battery | Graphite-based | 1 M LiPF₆/ | 251 | 161 |
| | 1 | material A | EC:DMC/ | | |
| | | | DEC = 1:1:1 | | |
| Example 4 | Battery | Graphite-based | 1 M LiPF6 + | 260 | 166 |
| | 11 | material A | 0.01 M LB/ | | |
| | | | EC:DMC/DEC/ | | |
| | | | MA = :3:3:3:1 | | |

### EXAMPLE 5

18650 cylindrical lithium ion secondary batteries (Battery 12), (Battery 13), (Battery 14), (Battery 15) and (Battery 16) were manufactured as Example 5 of the present invention as follows.

As the positive-electrode active materials, a composite oxide powder represented by LiNi_{0.4}Mn_{0.4}Co_{0.2}O₂, a composite oxide powder represented by LiNi_{0.28}Mn_{0.5}Co_{0.1}Cr_{0.1}Al_{0.01}Mg_{0.01}O₂, an Ni-based composite oxide powder represented by LiNi_{0.8}Co_{0.15}Al_{0.05}O₂, a spinel-based positive-electrode active material powder represented by LiMn₂O₄ and LiCoO₂ (lithium cobalt oxide) powder were used in (Battery 12), (Battery 13), (Battery 14), (Battery 15) and (Battery 16), respectively. The coating weight of the positive electrode in (Battery 15) was 10.0 mg/cm². Lithium ion secondary batteries were manufactured in the same manner as (Battery 1) of Example 1 except for the above.

Table 4 shows positive electrode active materials and the measurement results of output densities at −30° C. at an SOC of 50% and an SOC of 30% for (Battery 1) of Example 1 and the batteries of Example 5. As shown in Table 4, the output density of (Battery 1) was 251 W/kg at an of SOC 50% and 161 W/kg at an SOC of 30%, the output density of (Battery 12) was 247 W/kg at an SOC of 50% and 158 W/kg at an SOC of 30%, the output density of (Battery 13) was 240 W/kg at an SOC of 50% and 158 W/kg at an SOC of 30%, the output density of (Battery 14) was 230 W/kg at an SOC of 50% and 157 W/kg at an SOC of 30%, the output density of (Battery 15) was 236 W/kg at an SOC 50% of and 155 W/kg at an SOC of 30%, and the output density of (Battery 16) was 231 W/kg at an SOC of 50% and 150 W/kg at an SOC of 30%. All the batteries of Example 5 had an output density of 230 W/kg or more at an SOC of 50% and 150 W/kg or more at an SOC of 30%, which means that they were superior to the batteries of Comparative Examples in output density. (Battery 1), (Battery 12) and (Battery 13) had an output density of 240 W/kg or more at an SOC of 50% which were higher than those of (Battery 15) and (Battery 16). (Battery 14) had an output density higher than 165 W/kg at an SOC of 30% which was higher than those of (Battery 15) and (Battery 16).

TABLE 4

| | | | | Output at −30° C. | |
|---|---|---|---|---|---|
| | | Negative- | | (W/kg) | |
| | | electrode | | SOC of | SOC of |
| | Battery | active material | Electrolyte | 50% | 30% |
| Example 1 | Battery | Graphite-based | LiNi_{0.34}Mn_{0.33}Co_{0.33}O₂ | 251 | 161 |
| | 1 | material A | | | |
| Example 5 | Battery | Graphite-based | LiNi_{0.40}Mn_{0.33}Co_{0.33}O₂ | 247 | 161 |
| | 12 | material A | | | |
| | Battery | Graphite-based | LiNi_{0.28}Mn_{0.5}Co_{0.1}Cr_{0.1}Al_{0.01}Mg_{0.01}O₂ | 240 | 158 |
| | 13 | material A | | | |
| | Battery | Graphite-based | LiNi_{0.80}Co_{0.15}Al_{0.05}O₂ | 230 | 157 |
| | 14 | material A | | | |
| | Battery | Graphite-based | LiMn₂O₄ | 236 | 155 |
| | 15 | material A | | | |
| | Battery | Graphite-based | LiCoO₂ | 231 | 150 |
| | 16 | material A | | | |

### EXAMPLE 6

In this Example, an electric car having a motor as a power unit and wheels as drive units is shown as an example of an apparatus having a power unit comprising the lithium ion secondary battery of the present invention as at least part of a power source and drive units driven by the power unit.

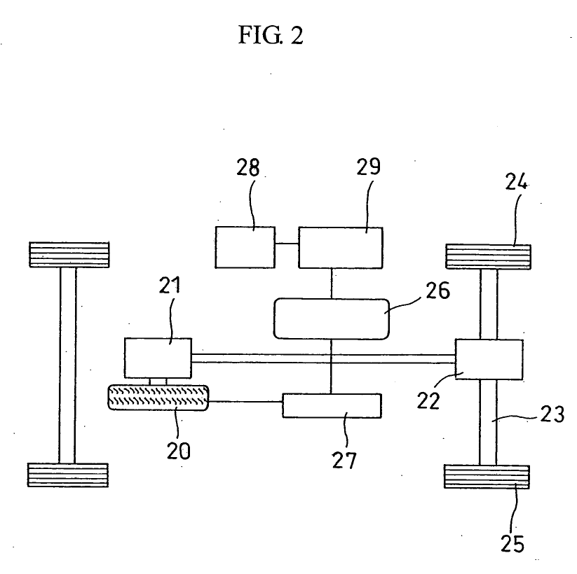

FIG. 2 shows the constitution of the electric car of the present invention. Power generated by a motor 20 turns a wheel shaft 23 via a transmission 21 and an axle 22, whereby wheels 24 and 25 as drive units turn. The power source is an assembled battery unit 26 assembled by connecting the lithium ion secondary battery of the present invention in series or parallel, and power from this combined battery unit is supplied to the motor 20 via an inverter 27. Power from the battery unit is controlled by an assembled battery control mechanism 29 in accordance with the operation of an accelerator 28.

The electric car of this Example comprises the lithium ion secondary battery of the present invention having high output power at an extremely low temperature, for example, −30° C. and even in a low charged state as a power source. Therefore, a great acceleration effect can be expected from the electric car of the present invention even in subzero environment in a cold district. As this lithium ion secondary battery of the present invention has high output power in a low charged state, the electric car of the present invention can ensure acceleration performance irrespective of the charged state of the battery when it is at a standstill.

1. A lithium ion secondary battery comprising electrodes consisting of a positive electrode coated with a positive-electrode depolarizing mix containing a positive-electrode active substance, a negative electrode coated with a negative-electrode depolarizing mix containing a negative-electrode active substance and a separator and containing an electrolyte, wherein
it has an output density based on the total weight of the electrodes at −30° C. of 230 W/kg or more at an SOC of 50% and 150 W/kg or more at an SOC of 30%.

2. A lithium ion secondary battery comprising electrodes consisting of a positive electrode coated with a positive-electrode depolarizing mix containing a positive-electrode active substance, a negative electrode coated with a negative-electrode depolarizing mix containing a negative-electrode active substance and a separator and containing an electrolyte, wherein
the negative-electrode active substance is a graphite-based material having an R value (I_{RD}/I_{RG}) which is the ratio of peak intensity (I_{RD}) at 1,300 to 1,400 cm⁻¹ to peak intensity (I_{RG}) at 1,580 to 1,620 cm⁻¹ measured in its Raman spectrum of 0.3 to 0.6 and an H value (I_{H(110})/I_{H(004)}) which is the ratio of the peak height intensity (I_{H(110)}) of the face (110) to the peak height intensity (I_{H(004)}) of the face (004) in its X-ray diffraction of 0.5 to 2.0 or a C value which is the ratio of the peak integral intensity (I_{C(110)}) of the face (110) to the peak integral intensity (I_{C(004)}) of the face (004) of 0.4 to 1.50.

3. The lithium ion secondary battery according to claim 2, wherein the half-value width Δ of a peak at 1,300 to 1,400 cm⁻¹ measured in the Raman spectrum of the graphite-based material is 40 to 100 cm⁻¹.

4. The lithium ion secondary battery according to claim 2, wherein the average particle diameter of the graphite-based material is 2 to 20 μm.

5. The lithium ion secondary battery according to claim 2, wherein the coating weigh of the negative-electrode depolarizing mix is 1.5 to 6.0 mg/cm² and the negative-electrode depolarizing mix contains 1 to 10 wt % of a conducting agent.

6. The lithium ion secondary battery according to claim 2, wherein a solvent for the electrolyte contains a nitrate and/or the electrolyte contains a salt of lithium and organic boric acid (the boric acid has a carboxyl-derived group having a halogen-substituted alkyl group).

7. The lithium ion secondary battery according to claim 2, wherein the positive-electrode mix contains a layered composite oxide represented by LiNiₓMn_{y}Co_{z}M_{α}O₂ (M; Fe, Cr, Cu, Al, Mg or Si, x+y+z+α=1, 0.2≦x≦0.5, 0.25≦y≦0.7, 0.1≦z≦0.5, 0≦α≦0.1) as a positive-electrode active material.

8. The lithium ion secondary battery according to claim 2, wherein the positive-electrode mix contains a layered composite oxide represented by LiNiₓM₁₋ₓO₂ (M: Mn, Co, Fe, Cr, Cu, Al or Mg, 0.7≦x≦0.95) as a positive-electrode active material.

9. An apparatus comprising the lithium ion secondary battery of claim 1, a power unit using the lithium ion secondary battery as at least part of a power source, and a drive unit driven by the power unit.

10. An apparatus comprising the lithium ion secondary battery of claim 2, a power unit using the lithium ion secondary battery as at least part of a power source, and a drive unit driven by the power unit.
